(19) United States
(12) Patent Application Publication
(10) Pub. No.: US 2002/0150117 A1
(43) Pub. Date: Oct. 17, 2002

(54) Data repeater equipment having bandwidth control function, and bandwidth managing apparatus

(76) Inventor: Hidekazu Baba, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/056,555

(22) Filed: Jan. 25, 2002

(30) Foreign Application Priority Data
Mar. 27, 2001 (JP) 2001-90806

(51) Int. Cl. H04B 7/212

(52) U.S. Cl. 370/442; 370/477; 370/468

(57) ABSTRACT

A data repeater equipment which is capable of automatically setting ideal bandwidths that match the traffic amount, without requiring human work, and capable of setting bandwidths that are compatible between a plurality of data repeater equipment. This includes: a traffic amount holding unit for holding the traffic amount measured at every short-term period; and a bandwidth adjusting unit for calculating an average traffic amount at every long-term period based on the measured traffic amount, comparing a bandwidth value corresponding to this calculated average traffic amount with a first preset bandwidth value, thereby to obtain a difference between the two values, and re-setting the first preset bandwidth value to a second preset bandwidth value that minimizes this difference. The data repeater equipment further includes an alteration request unit for altering a preset bandwidth value, and this alteration request unit communicates with a bandwidth determination managing apparatus to make request and obtain permission to alter the preset bandwidth value.

### BACKGROUND OF THE INVENTION

1. Field of the Invention

The present invention relates to data repeater equipment for structuring a data communication network like a router and a LAN switch, and relates, more particularly, to data repeater equipment having a bandwidth control function.

In recent years, along the development of the Internet/Intranet, all the communication data including voice (telephone) data, in addition to information-based processing data and basic job-based processing data, has come to be transferred to the same data communication network.

Under the circumstances, a large amount of packets forming information-based data that do not require real-time operability have come to be transferred to the network, like a mere transfer of files, for example. This has brought about a serious problem that the packets forming basic job-based processing data and voice communication data that require very strict real-time operability are discarded in the data repeater equipment, like the transfer of bank deposit information, for example. This results in an interruption of basic jobs, and disconnection of communications.

In order to avoid this problem, in recent years, most of the data repeater equipment have a function called “bandwidth control”. This is a function for assuring a bandwidth or limiting a bandwidth to be used for communications (such as, communications for a specific application, for example) that satisfy specific conditions. When this bandwidth control function is used, it becomes possible to assure the use of a constant bandwidth allotted in advance to the above-described basic job-based (or voice) data packets, even if a large amount of the above-described information-based data packets are being transferred to the network. Accordingly, this bandwidth control has called attention as a very important function in the data communication network.

The present invention describes a method of improving this “bandwidth control function”.

2. Description of the Related Art

While the bandwidth control function is a technique that becomes increasingly important in future, this function has a large operational problem in that it is very difficult to set a bandwidth value in practice, as described later in detail with reference to drawings. This holds a first problem and a second problem as explained later in detail with reference to drawings.

In short, the first problem is as follows.

It is not so important to modify a preset bandwidth corresponding to each variation in a short-term traffic amount. However, when a long-term average traffic amount has changed substantially, it is important to alter the preset bandwidth for data repeater equipment. For this purpose, a huge amount of work becomes necessary. For example, it is always necessary to keep monitoring traffic amount, periodically reviewing the setting based on this monitoring, and altering the setting. Consequently, this kind of alteration is not carried out in practice.

The second problem is summarized as follows.

The above-described periodical alteration of the preset bandwidth itself requires a hard work. On top of this, when a preset bandwidth for certain data repeater equipment is altered, it additionally becomes necessary to alter the preset bandwidth for other data repeater equipment than this data repeater equipment, thereby to adjust the whole preset bandwidths to make them compatible in the whole communication channels. Consequently, this additional requirement results in huge work further.

### SUMMARY OF THE INVENTION

In the light of the above problems, it is, therefore, a first object of the present invention to make it possible to automatically set ideal bandwidths that match the traffic amount, without requiring human work (the solving of the above first problem). Further, when a plurality of data repeater equipment sharing the same communication channel exist, it is a second object of the invention to make it possible to set bandwidths compatible between the data repeater equipment in the communication channel, by automatically setting the bandwidth for each data repeater equipment (the solving of the above second problem).

In order to achieve the above objects, according to the present invention, there is provided data repeater equipment that includes: traffic amount holding means (21) for holding the traffic amount measured at every short-term period; and bandwidth adjusting means (22) for calculating an average traffic amount at every long-term period, comparing a bandwidth value corresponding to this calculated average traffic amount with a first preset bandwidth value, thereby to obtain a difference between the two values, and resetting the first preset bandwidth value to a second preset bandwidth value that minimizes this difference. Preferably, the data repeater equipment further includes alteration request means (23) for altering a preset bandwidth value, and this alteration request means (23) communicates with a bandwidth determination managing apparatus (24) to make request and obtain permission to alter the preset bandwidth value.

Due to the above arrangement, it becomes possible to automatically carry out ideal setting of bandwidths that match the traffic amount, without requiring human work, and it becomes possible to determine bandwidths compatible between a plurality of data repeater equipment.

### BRIEF DESCRIPTION OF THE DRAWINGS

The above objects and features of the present invention will be more apparent from the following description of the preferred embodiments given with reference to the accompanying drawings, wherein:

FIG. 1 is a diagram showing a basic structure of data repeater equipment relating to the present invention;

FIG. 2 is a diagram showing a basic structure of a bandwidth determination managing apparatus;

FIG. 3 is a diagram showing a modification of the structure of FIG. 1;

FIG. 4 is a diagram showing one embodiment of the data repeater equipment relating to the present invention;

FIG. 5 is a block diagram showing one example of conventional data repeater equipment;

FIG. 6 is a flowchart showing an outline of the operation of a traffic amount record control unit (51 in FIG. 4);

FIG. 7 is a diagram showing a record table within a traffic amount recording unit (52 in FIG. 4);

FIG. 8 is a flowchart for explaining a first example of algorithm;

FIG. 9 is a graph showing an operation image based on the first example of algorithm;

FIG. 10 is a flowchart for explaining a second example of algorithm;

FIG. 11 is a graph showing an operation image based on the second example of algorithm;

FIG. 12 is a flowchart showing an outline of the operation of an alteration permission requesting unit 54;

FIG. 13 is a diagram showing one example of a request command from the alteration permission requesting unit 54;

FIG. 14 is a flowchart showing an operation algorithm of a bandwidth determination management server 55;

FIG. 15 is a diagram showing one example of a data communication network to which the present invention is applied;

FIG. 16 is a diagram showing one example of a data communication network in which the data repeater equipment does not have a bandwidth control function;

FIG. 17 is a diagram for explaining effects of a general bandwidth control function; and

FIG. 18 is a diagram for explaining a second problem separate from a first problem explained in FIG. 16.

### DESCRIPTION OF THE PREFERRED EMBODIMENTS

Before describing the embodiments of the present invention, the related art and the disadvantages therein will be described with reference to the related figures.

As described above, the bandwidth control function assures a requested use of a bandwidth for communications that satisfies specific conditions, or determines an upper limit bandwidth to be used for the communications. With this arrangement, it becomes possible to minimize the discarding of packets for the communications, even if packets provided for a plurality of kinds of communications (information-based and basic job-based applications) are transferred to the same data communication network.

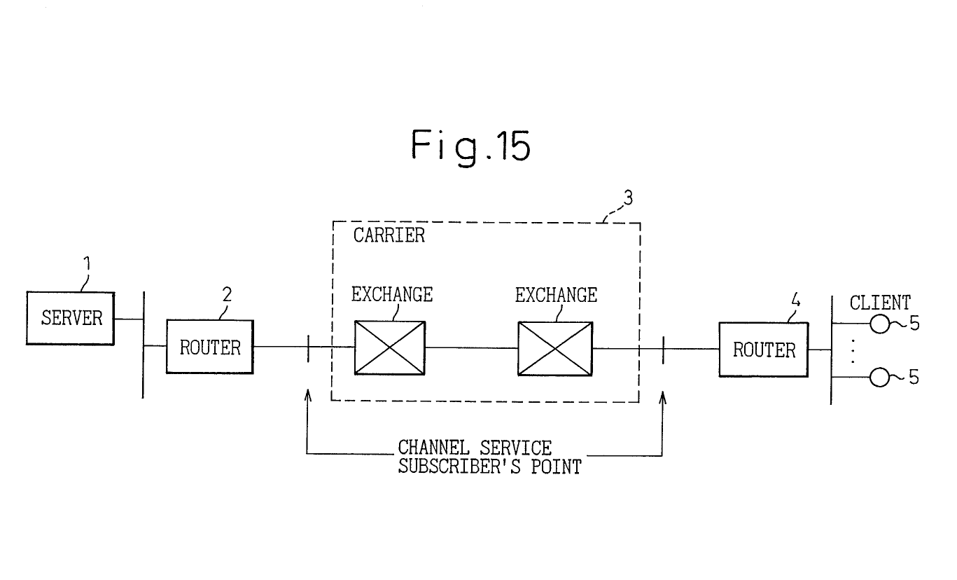

FIG. 15 is a diagram showing one example of a data communication network to which the present invention is applied. In the drawing, a reference number 1 denotes a server that is installed in the head office of a certain company, for example. A reference number 5 denotes clients (PCs: personal computers) installed in a plurality of operating offices under the control of the server 1 respectively. Data communications between the clients 5 and the server 1 are carried out via a carrier (for example, NTT) 3 that has exchanges. In this case, each packet for the data communications is routed to a repeater path, corresponding to an IP address for example. A data repeater equipment executes this repeating. Specifically, this is a router or a LAN switch. FIG. 15 shows a status that routers 2 and 4 are installed at the server 1 side and the client 5 side respectively as one example of the data repeater equipment (hereinafter, the data repeater equipment will also be simply referred to as a router).

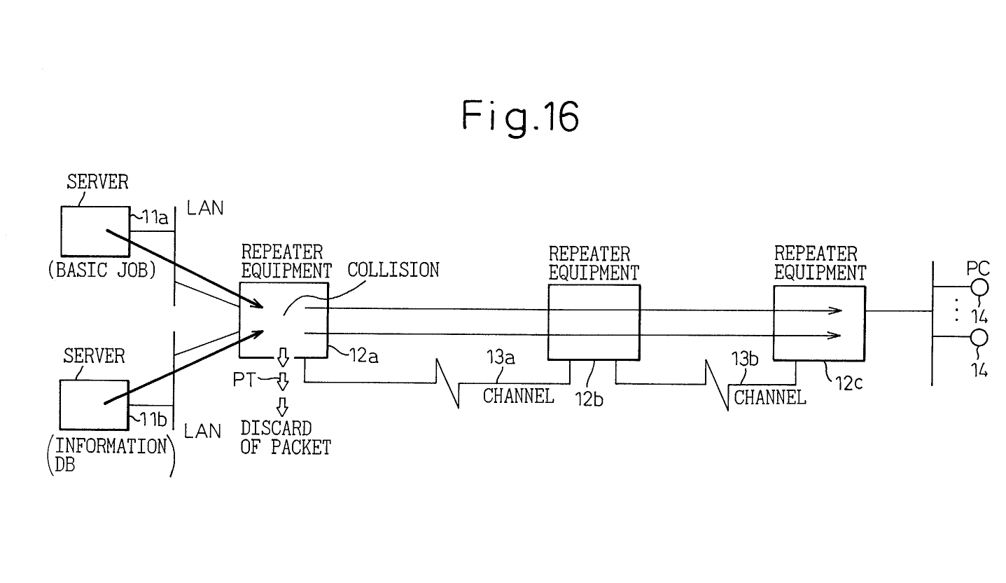

FIG. 16 is a diagram showing one example of a data communication network in which the data repeater equipment does not have a bandwidth control function.

In FIG. 16, PCs 14 as clients are making access to servers 11a and 11b via data repeater equipment 12a, 12b and 12c that are connected via channels 13a and 13b. As one example, the data repeater equipment 12a, 12b and 12c are the data repeater equipment installed in a head office, a plurality of branch offices under the control of the head office, and a plurality of operating offices under the control of the branch offices, respectively.

The server 11a is a server for the above-described basic job-based processing, and the server 11b is a server as a database (DB) for the above-described information-based processing. Communications with the server 11a require strict real-time response, and must minimize the discarding of packets as far as possible. On the other hand, this requirement is less strict for communications with the server 11b. In other words, packets PTs that have been discarded due to the collision can be recovered when these packets are transmitted again. So long as all the data can be finally downloaded, this is sufficient even if it takes time.

In general, the bandwidths of the channels 13a and 13b are very small as compared with those of LANS. Accordingly, it often happens that the total amount of data transmitted from the servers 11a and 11b that are connected to the LAN exceeds the bandwidth of this channel. For example, assume that the server 11a transmits data of 60 Kbps and the server 11b transmits data of 196 Kbps respectively, when the channel 13a has a bandwidth of 128 Kbps. In this case, a collision of packets occurs at a point of time when the data repeater equipment 12a transmits these data to the channel 13a. Consequently, a discarding of packets occurs.

In this case, the total amount of data transmitted from the data repeater equipment 12a is 256 Kbps, which is two times the bandwidth (128 Kbps) of the channel 13a. Therefore, a half of the total transmission packets are discarded.

Attention should be paid to the fact that, in FIG. 16, the half of the packets are discarded not only for communications with the server 11b that allows a discarding of packets, but also for communications with the server 11a that should avoid discarding of packets to a minimum extent. When this situation lasts, the basic job-based applications hang up, and communications are disconnected during the processing of the basic jobs. This brings about a status that all the accumulated work is lost.

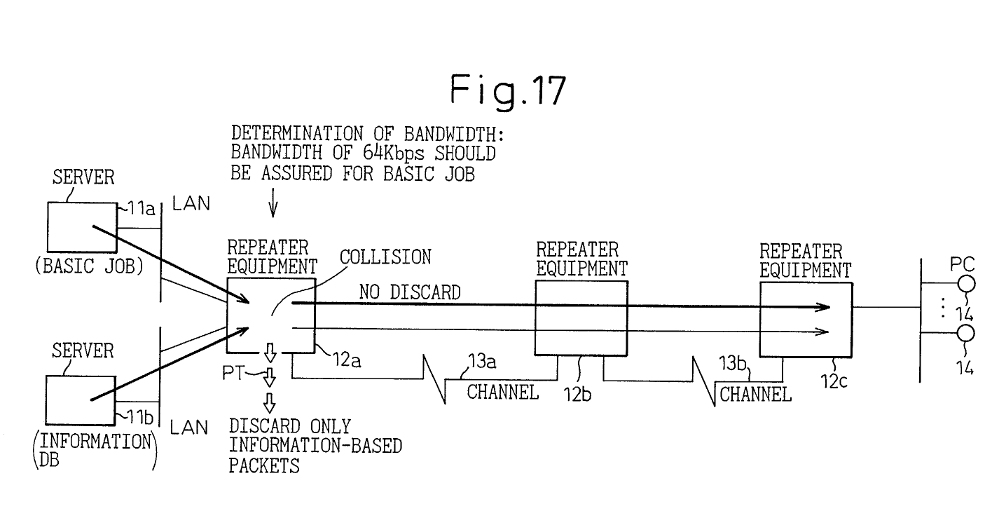

FIG. 17 is a diagram for explaining effects of a general bandwidth control function.

From this drawing, it becomes clear that the bandwidth control function can solve the above status that the basic job-based applications hang up, and the work achieved so far is lost during the processing of the basic jobs.

In FIG. 17, the data repeater equipment 12a has the bandwidth control function, and it is possible to set an instruction “Assure the bandwidth of 64 Kbps for basic jobs, out of the total bandwidth of the channel 13a” to the data repeater equipment 12a in advance. Based on this setting, when a data (packet) collision has occurred, the data repeater equipment 12a can judge whether a packet belongs to the communications with the server 11a or the communications with the server 11b, and can maintain the above setting (the assuring of 64 Kbps). In the above example, as the data amount of the server 11a for basic job-based communications is 60 Kbps and this is within the guaranteed bandwidth (64 Kbps), all the data (packets) for the basic jobs can be transmitted to the channel 13a without discarding. However, on the other hand, most of the information-based data (packets) of the server 11b is discarded by that amount. It should be understood, however, that this discarding in the information-based communication is not a serious problem, as described above.

As a result, in FIG. 17, even if the information-based communication side transfers a large amount of data, this does not interrupt the basic job-based communications. This is the effect of the bandwidth control function.

As described above, although the bandwidth control function becomes an increasingly important technique in future, this function has the large first and second operational problems in that it is very difficult to set a bandwidth value in practice. These problems will be explained with reference to FIG. 17 again.

The first problem is that it is always necessary to keep adjusting preset bandwidth values during the operation, as the average traffic amount of communications dynamically changes based on changes in the application status of the network. For example, the instruction “Assure the bandwidth of 64 Kbps for basic jobs, out of the total bandwidth (128 Kbps) of the channel 13a” is set to the data repeater equipment 12a in advance, in the above explanation with reference to FIG. 17. As the traffic amount of the packets to be transmitted from the server 11a has been set to 60 Kbps, this setting has been effective, in actual practice.

However, the average traffic amount of the packets transmitted from the server 11a varies dynamically in actual practice, due to changes in the operational status, such as an increase/decrease in the basic jobs, an increase/decrease in the number of user, changes in job time, etc. For example, when information-based traffics have collided in the status that the average traffic amount of the packets transmitted from the server 11a has increased to 90 Kbps, packets corresponding to the bandwidth of 26 (=90−64) Kbps discarded. This brings about a trouble in the basic jobs. In this case, it is necessary to change the instruction for the setting of the bandwidth to “Assure 100 Kbps for basic job-based communications”, for example.

On the other hand, assume that the average traffic amount of the packets transmitted from the server 11a has decreased to 30 Kbps. In this case, the basic jobs have not trouble. However, as the data repeater equipment 12a has secured the bandwidth of 64 Kbps for basic job-based communications based on the above instruction, the bandwidth of 34 (=64−30) Kbps becomes always wasteful. In this case, the bandwidth setting should be changed to “Assure 32 Kbps for basic job-based communications”, for example. With this arrangement, the wasteful bandwidths should be utilized for information-based communications, so that it becomes possible to effectively utilize the channel.

It is not so important to modify a preset bandwidth corresponding to each variation in a short-term traffic amount. However, when a long-term average traffic amount has changed substantially, it is important to alter the preset bandwidth for data repeater equipment, as described above. For this purpose, a huge amount of work is necessary. For example, it is always necessary to keep monitoring traffic amount, periodically reviewing the setting based on this monitoring, and altering the setting. Consequently, this kind of alteration is not carried out in practice. This is the first problem as described above.

The second problem of the conventional bandwidth control function is that it is difficult to match the distribution of the respective preset bandwidths over the plurality of data repeater equipment 12a, 12b and 12c.

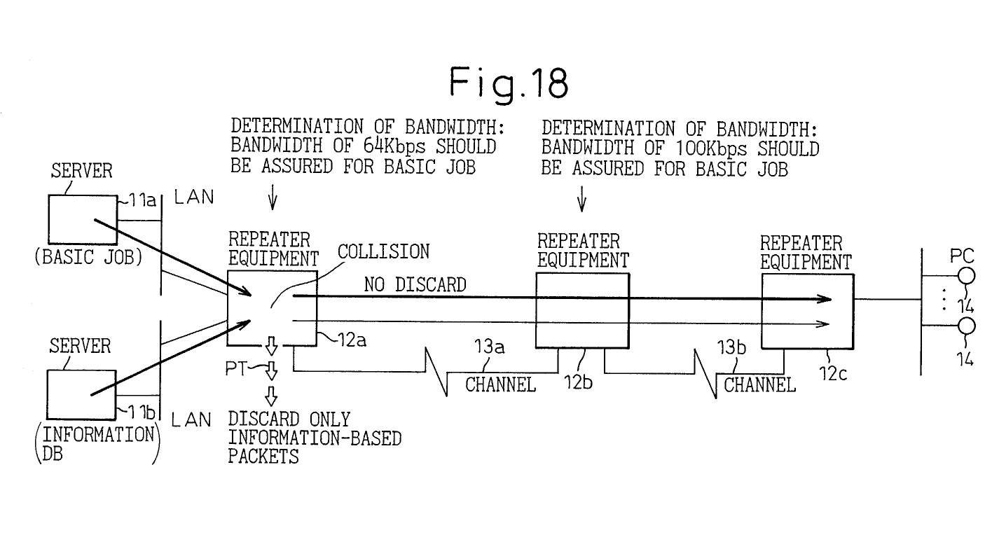

FIG. 18 is a diagram for explaining the second problem separate from the first problem explained in FIG. 16. In FIG. 18, constituent elements are identical to those used in FIG. 16.

In FIG. 18, it is assumed that a bandwidth setting of “Assure 64 Kbps for basic job-based communications” has been instructed to the data repeater equipment 12a, like in FIG. 17. It is also assumed that a bandwidth setting of “Assure 100 Kbps for basic job-based communications” has been instructed to the next-stage data repeater equipment 12b. It is also assumed that there is no other server than the server 11a and the server 11b, and that the traffic amount for basic job communications incoming from the channel 13a does not exceed 64 Kbps. In this case, the above bandwidth setting for the data repeater equipment 12b is apparently wasteful. Accordingly, it is necessary to increase the bandwidth of the information-based traffic for the server 11b, by setting the same bandwidth of the data repeater equipment 12a to the bandwidth of the data repeater equipment 12b.

Considering the fact that a network for repeating data is generally structured by a plurality of data repeater equipment, it is necessary that the bandwidths for the data repeater equipment are set compatible with each other. In this case, the term “compatible” does not mean the “same values”, but this means that the bandwidths are set rationally without waste, like “the total of bandwidths ensured on the downstream channel becomes equal to the bandwidths ensured on the upstream channel” in the case of branching the channels.

As described above, it requires hard work to carry out the periodical alteration of the preset bandwidths. When a preset bandwidth for certain data repeater equipment is altered in this status, it becomes further necessary to alter the preset bandwidth for other data repeater equipment than this data repeater equipment in order to adjust the total preset bandwidths to make them compatible in the whole communication channels. Consequently, this additional requirement results in huge work further. This is the above-described second problem.

In the light of the above problems, the present invention makes it possible to automatically set ideal bandwidths that match the traffic amount, without requiring human work, thereby solving the above first problem. Further, when a plurality of data repeater equipment sharing the same communication channel exist, the present invention makes it possible to set bandwidths compatible between the data repeater equipment in the communication channel, by automatically setting the bandwidth for each data repeater equipment. In this way, the above second problem is solved.

The present invention will now be explained in detail below.

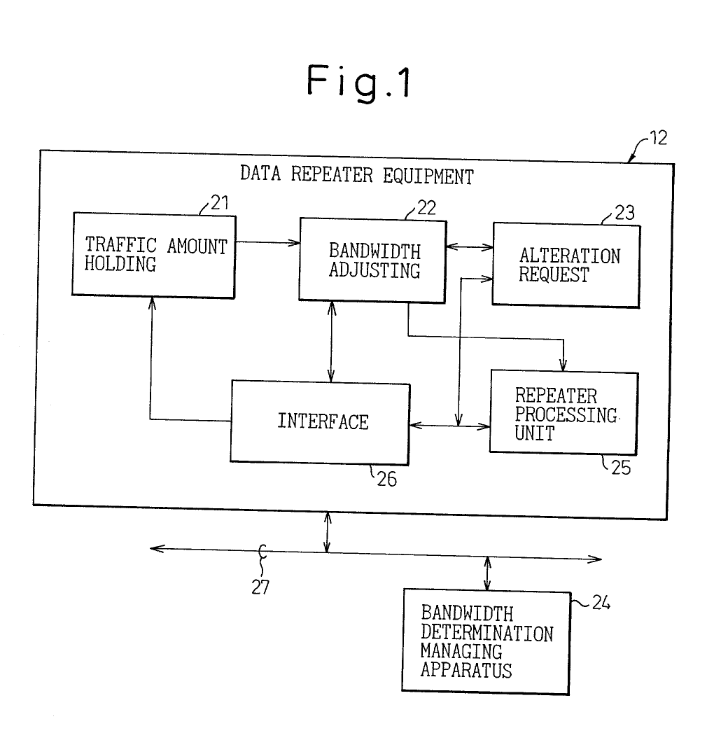

FIG. 1 is a diagram showing a basic structure of data repeater equipment relating to the present invention.

In FIG. 1, data repeater equipment 12 relating to the present invention has traffic amount holding means 21, bandwidth adjusting means 22, alteration request means 23, and a bandwidth determination managing apparatus 24, as main constituent elements of the present invention. Further, the data repeater equipment 12 has a repeater processing unit 25, and an interface 26, as other constituent elements that cooperate with the above main constituent elements. In FIG. 1, a reference number 27 denotes a communication channel, and this corresponds to the above-described channels 13a and 13b.

More specifically, the traffic amount holding means 21 holds a traffic amount measured at every short-term period.

The bandwidth adjusting means 22 calculates an average traffic amount at every long-term period based on a traffic amount held in the traffic amount holding means 21, compares a bandwidth value corresponding to the calculated average traffic amount with a first preset bandwidth value, thereby to obtain a difference between the two, and re-sets this first preset bandwidth value to a second preset bandwidth value that minimizes this difference.

Further, there is provided the interface 26 for cooperating with the bandwidth determination managing apparatus 24 that integrally manages the bandwidths of a plurality of data repeater equipment 12a, 12b, and 12c respectively, via the communication channel 27.

The alteration request means 23 that cooperates with the bandwidth determination managing apparatus 24 requests this apparatus 24 to permit the alteration of the first preset bandwidth value to the second preset bandwidth value. The alteration request means 23 communicates with the bandwidth determination managing apparatus 24 to make this request and obtain permission, via the interface 26. Then, the alteration request means 23 either permits or inhibits the bandwidth adjusting means 22 to execute the adjustment, according to a decision made by the bandwidth determination managing apparatus 24.

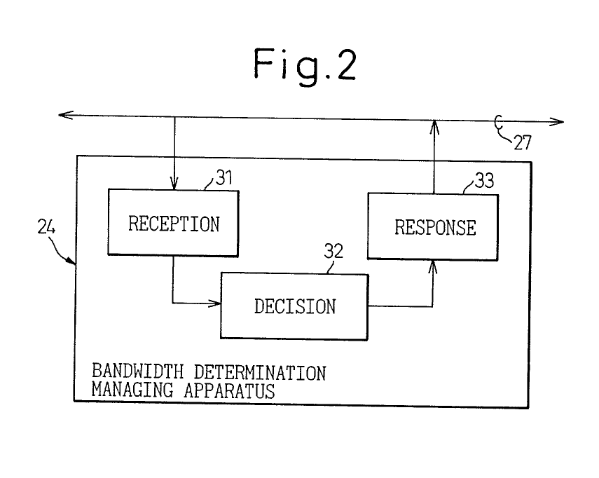

FIG. 2 is a diagram showing a basic structure of the bandwidth determination managing apparatus.

As shown in FIG. 2, the bandwidth determination managing apparatus 24 is composed of reception means 31, decision means 32, and response means 33.

Specifically, these means cooperate with each of the plurality of data repeater equipment 12a, 12b, and 12c. The reception means 31 receives a request for altering a bandwidth setting, from any one of data repeater equipment. The decision means 32 holds a plurality of conditions relating to the bandwidth setting, and decides whether the request satisfies all the conditions or not. The response means 33 makes response to the data repeater equipment to permit the request when the request satisfies all the conditions as a result of the decision made, and not to permit the request when the request does not satisfy all the conditions.

As explained above, the bandwidth determination managing apparatus 24 holds a plurality of predetermined conditions. When the bandwidth determination managing apparatus 24 has received a request for altering the setting of the first preset bandwidth value to the second preset bandwidth value from the alteration request means 23, the bandwidth determination managing apparatus 24 decides whether this second preset bandwidth value satisfies all the conditions or not. When the second preset bandwidth value satisfies all the conditions, the bandwidth determination managing apparatus 24 permits the alteration request means 23 to alter the first preset bandwidth value to the second preset bandwidth value.

Referring back to FIG. 1, the repeater processing unit 25 performs the basic function to be achieved by the data repeater equipment 12. In the data repeater equipment 12 relating to the present invention, the repeater processing unit 25 executes at least the repeat processing of a packet PT to be handled along the communication channel 27, and a bandwidth control function. The bandwidth adjusting means 22 executes the bandwidth control to be applied to the repeater processing unit 25.

For this automatic bandwidth control, the alteration request means 23 and the bandwidth determination managing apparatus 24 become the important constituent elements as a pair in the present invention. However, there is a case where it is not possible to introduce the bandwidth determination managing apparatus 24 because of cost or installation space, for example. In this case, it is possible to employ the following alteration decision means.

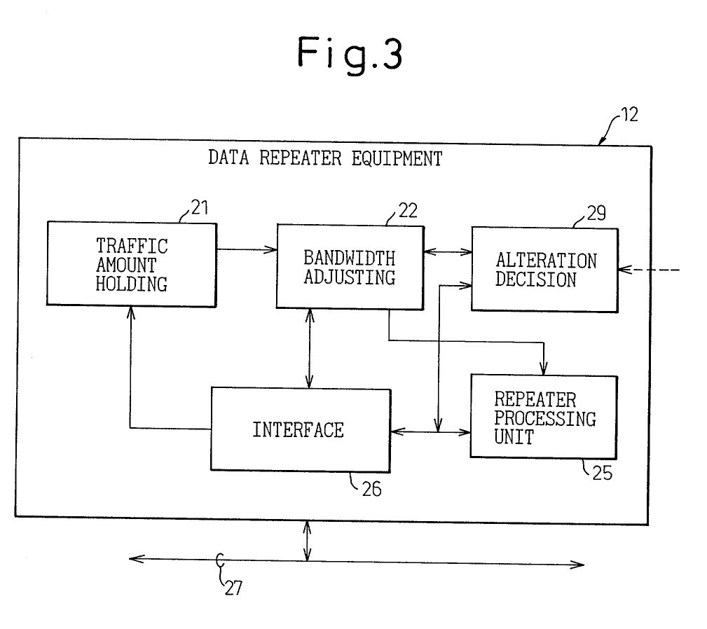

FIG. 3 is a diagram showing a modification of the structure of FIG. 1.

In this modification, alteration decision means 29 is employed in place of the above means 23 and apparatus 24.

In other words, within the data repeater equipment 12, there is provided the alteration decision means 29 for deciding whether it is possible to permit the alteration of the first preset bandwidth value to the second preset bandwidth value or not. The alteration decision means 29 either permits or inhibits the bandwidth adjusting means 22 to execute the adjustment, based on the decision made.

In this case, it is necessary to obtain bandwidth setting information of other data repeater equipment. This information can be obtained based on communications with the other data repeater equipment via the communication channel 27. Alternatively, it is also possible to obtain this information as external information (indicated by a dotted line in the drawing) by certain means.

Accordingly, the alteration decision means 29 holds a plurality of predetermined conditions, and decides whether the second preset bandwidth value satisfies all the conditions or not. The alteration decision means 29 permits the alteration of the first preset bandwidth value to the second preset bandwidth value only when the second preset bandwidth value satisfies all the conditions.

As explained above, according to the present invention, each data repeater equipment (12a, 12b, 12c) always monitors traffic amount, keeps record of the traffic amount, periodically compares the record of the traffic amount with a preset bandwidth value at every long-term period, and updates the preset bandwidth value so as to minimize a difference between the two values. Therefore, it is possible to automatically optimize the preset bandwidth value, without requiring human work.

Further, before making an alteration of the preset bandwidth value, each data repeater equipment requests the bandwidth determination managing apparatus 24 to permit the alteration. Further, the bandwidth determination managing apparatus 24 permits the alteration only after confirming that the bandwidth setting after the alteration becomes compatible between the plurality of data repeater equipment (12a, 12b, 12c). Therefore, based on the automatic updating of the preset bandwidth value, it is possible to prevent the occurrence of contradiction or incompatibility in the bandwidth setting between the data repeater equipment.

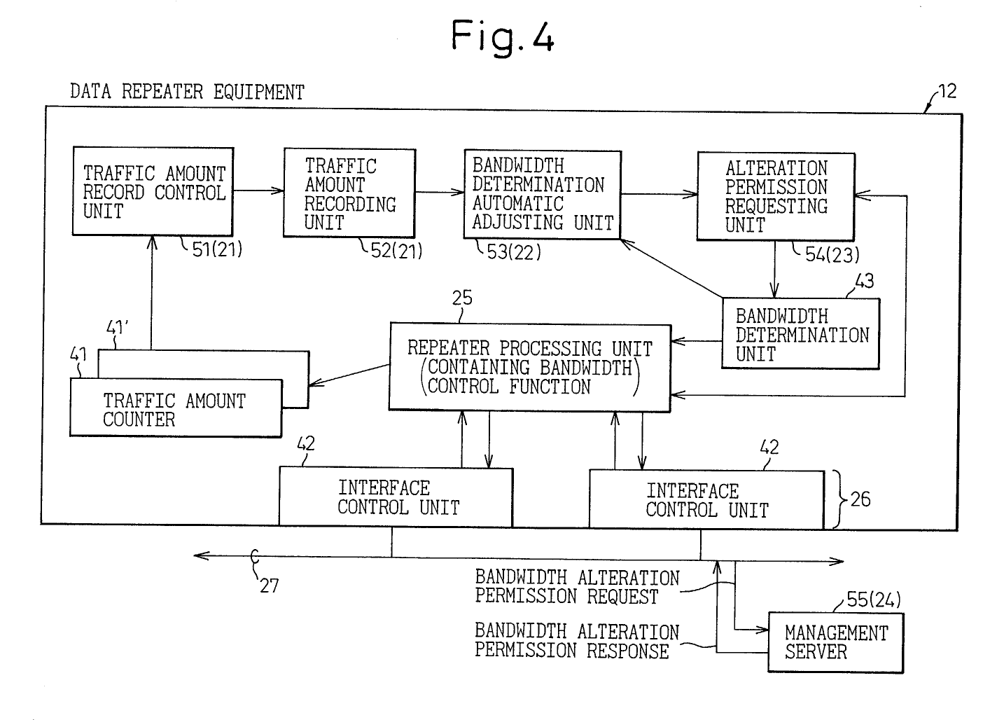

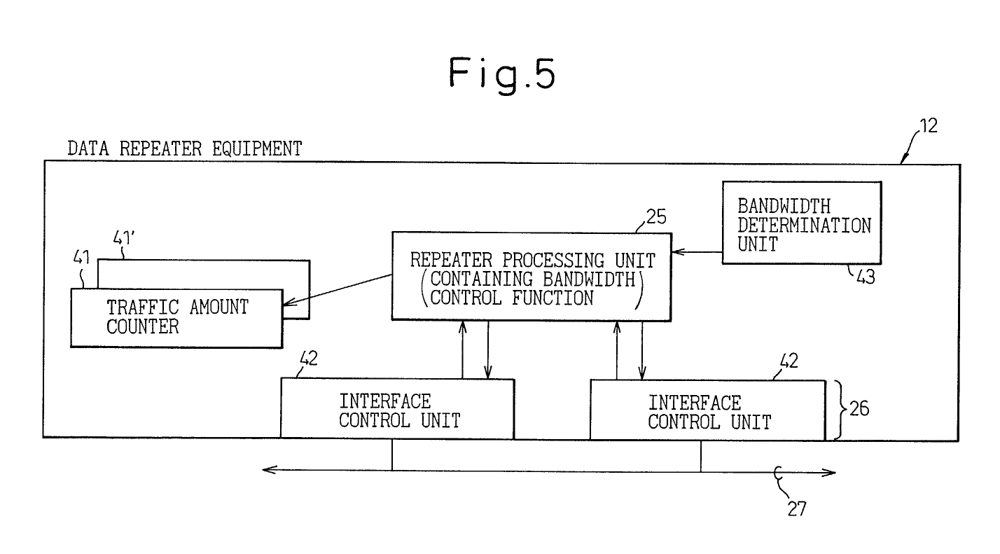

FIG. 4 is a diagram showing one embodiment of the data repeater equipment relating to the present invention. Further, FIG. 5 is a block diagram showing one example of conventional data repeater equipment. FIG. 5 is a drawing used to make it more clear the characteristics of the present invention shown in FIG. 4. Therefore, FIG. 5 will be explained first.

A reference number 12 denotes data repeater equipment. A reference number 42 denotes interface control units that cooperate with an interface 26. The interface control units 42 are the units for carrying out packet transmission/reception to/from a physical interface like a LAN or a channel (LAN, 13a, 13b in FIG. 16).

A reference number 25 denotes the repeater processing unit as described above. The repeater processing unit 25 executes processing necessary for packet repeating, such as a route selection (routing), a packet header rewriting, etc. The repeater processing unit 25 exchanges packets with the plurality of interface control units 42. The repeater processing unit 25 also has a bandwidth control function.

A reference number 43 denotes a bandwidth determination unit, which holds bandwidth setting information, and outputs a preset bandwidth value specified by the setting information to the repeater processing unit 25. With this arrangement, the repeater processing unit 25 can execute a bandwidth control.

Further, a reference number 41 denotes a traffic amount counter, which measures a traffic amount processed by the repeater processing unit 25, and accumulates the amount. It is possible to know the accumulated traffic amount up to a certain time, by reading the traffic amount accumulated by the traffic amount counter 41 at that time. The traffic amount counter 41 is independently provided for each basic job-based application and information-based application (41, 41′).

One embodiment of the present invention will be explained next with reference to FIG. 4. The outline of the embodiment will be explained first.

In general, most of data repeater equipment have a traffic amount counter for each interface accommodated, for the purpose of network management. This counter is provided for each application. In other words, a counter for a basic job-based traffic and a counter for an information-based traffic exist independently. These counters (a traffic amount measuring mechanism) will be collectively called here a “traffic amount counter”.

The data repeater equipment 12 in the present embodiment uses this existing traffic amount counter to periodically measure the average traffic amount for each application, and hold a result of this measurement as an “average traffic amount record”. Further, the data repeater equipment 12 periodically compares the “average traffic amount record” with a preset bandwidth value at every long-term period, and automatically updates the preset bandwidth value to minimize a difference between the two values.

When the preset bandwidth value is automatically changed, in actual practice, there is a risk that a bandwidth setting for a specific application becomes extremely large or extremely small. This may become a cause of inconvenience. For example, if a bandwidth is set to a level in excess of a channel capacity in a case where there exist frequent communications for a certain application, this makes it impossible to carry out communications for other application.

On the other hand, if a bandwidth is set to zero in a case where a certain application is seldom used, it becomes impossible to carry out communications for this application when necessary. In order to avoid such inconvenience, in actual practice, an upper limit and a lower limit are set to the bandwidth setting in advance, such as, for example, “From 10% to 90% of the channel capacity”. An automatic alteration of the bandwidth setting is carried out within this range.

With this arrangement, it becomes possible to automatically update the bandwidth setting, without requiring human work, even when a long-term average traffic amount has changed substantially. This corresponds to the first object of the present invention.

However, based on only the above automatic adjusting function, each data repeater equipment (12a, 12b, 12c) ends up altering respective bandwidth setting by itself based on respective local set information. This has a risk of the occurrence of incompatibility in the bandwidth setting in the data repeater network as a whole.

In order to solve the above problem, “a bandwidth determination management server 55” (one example of the bandwidth determination managing apparatus 24) is installed separately from the data repeater equipment. Based on this, an additional procedure is set such that, before each data repeater equipment automatically changes each bandwidth setting, the data repeater equipment issues a request to the bandwidth determination management server 55 to obtain a permission for the data repeater equipment to change the bandwidth setting.

When the bandwidth determination management server 55 has received the above request from each data repeater equipment (12a, 12b, 12c), the bandwidth determination management server 55 returns a permission/non-permission response to the data repeater equipment. The data repeater equipment that has received the permission response automatically changes the bandwidth setting. However, the data repeater equipment that has received the non-permission response keeps the current bandwidth without changing the currently set bandwidth. In this case, the data repeater equipment still compares the average traffic amount record with the preset bandwidth value at every long-term period, and makes request for permitting the change of the bandwidth setting, if necessary.

The bandwidth determination management server 55 is registered in advance with a plurality of relational expressions that must be satisfied in order to set bandwidths compatible between the data repeater equipment. For example, the bandwidth determination management server 55 is registered in advance with a condition that the total preset bandwidth value in the downstream channel must be within a range from 90% to 10% of the total preset bandwidth value in the upstream channel. When the request for changing the bandwidth setting has been received, the bandwidth determination management server 55 returns the permission only when all the relational expressions can be satisfied after the alteration as well.

Referring to FIG. 4, it is possible to realize the present embodiment by only adding functional blocks 51, 52, 53 and 59 to the conventional data repeater equipment (FIG. 5). Accordingly, it is not necessary to change the existing functional modules. It is possible to add these functions of the present invention to the conventional data repeater equipment with minimum work at low cost.

By installing a separate bandwidth determination management server 55, and by making the data repeater equipment communicate with this server, it is possible to achieve the second object of the present invention.

In FIG. 4, a reference number 51 denotes a traffic amount record control unit. The traffic amount record control unit 51 periodically checks a value of the traffic amount counter 41 or 41′ at every extremely short-term period (for example, one minute), takes a difference between this value and a value last time, and judges a traffic amount between this period (for example, one minute).

Further, the traffic amount record control unit 51 divides the traffic amount by the period, to obtain an average traffic amount in terms of a standard unit (for example, Kbps), and records this calculated value together with a measuring time in the traffic amount recording unit 52.

As is clear from the above operation, the traffic amount record control unit 51 (corresponding to a part of the traffic amount holding means 21) records the average traffic amount for each application (for example, a basic job-based application and an information-based application) in the standard unit (for example, Kbps) together with the measuring time, in this traffic amount recording unit 52. When the recording area becomes full, the old records are deleted, and new data is overwritten in this area.

A bandwidth determination automatic adjusting unit 53 (corresponding to the bandwidth adjusting means 22) periodically compares the record of the traffic amount recording unit 52 with the preset bandwidth value of the bandwidth determination unit 43 at every longer-term period than the traffic amount record control unit 51 (corresponding to a part of the traffic amount holding means 21). Then, the bandwidth determination automatic adjusting unit 53 determines a new bandwidth setting value between an upper limit value and a lower limit value given in advance, such that the preset bandwidth value of the bandwidth determination unit 43 becomes closer to the record of the traffic amount recording unit 52. Then, the bandwidth determination automatic adjusting unit 53 notifies the new setting value to an alteration permission requesting unit 54 (corresponding to the alteration request means 23).

In this case, various kinds of operation algorithms are considered for the bandwidth determination automatic adjusting unit 53. As the automatic adjustment of a preset bandwidth value itself is a main concern in the invention, the operation for automatically adjusting the bandwidth setting to optimize the setting based on a certain evaluation standard is the point of the present invention, regardless of a kind of the adjustment algorithm. A detailed example of algorithm will be described later.

When the alteration permission requesting unit 54 has received a notification from the bandwidth determination automatic adjusting unit 53, the alteration permission requesting unit 54 transmits a request for obtaining permission for the alteration of a bandwidth setting to the bandwidth determination management server 55. When there has been a response of non-permission from the bandwidth determination management server 55, the alteration permission requesting unit 54 makes no alteration. When there has been a response of permission from the bandwidth determination management server 55, the alteration permission requesting unit 54 writes the new setting value on the preset information in the bandwidth determination unit 43.

As described above, the traffic amount holding means 21 (51 and 52 in FIG. 4) divides the number of packets handled during the short-term period by the time corresponding to this period, and uses an obtained short-term average value as the traffic amount to be held.

On the other hand, the bandwidth adjusting means 22 (53 in FIG. 4) calculates a long-term average traffic amount using a predetermined algorithm. This predetermined algorithm is executed based on a predetermined program. Only this predetermined program can be replaced with any optional one of a plurality of kinds of programs, without changing the structure of the data repeater equipment 12. In other words, the predetermined algorithm changes locally. Thus, the change of the algorithm affects only the bandwidth determination automatic adjusting unit 53, and does not affect other functional blocks (for example, 51, 52 and 54). Therefore, it is possible to improve various functions of the data repeater equipment having the structure of the invention, by only rewriting software (program) of the bandwidth determination automatic adjusting unit 53.

The operation of the main functional blocks in FIG. 4 will be explained in detail below.

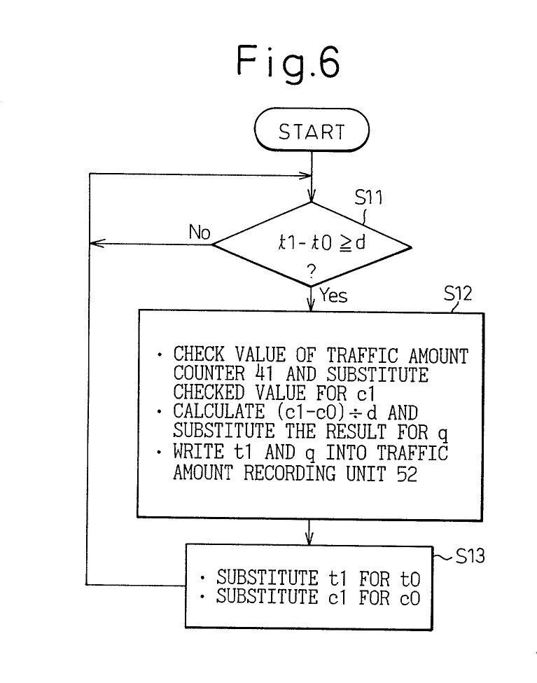

FIG. 6 is a flowchart showing an outline of the operation of the traffic amount record control unit (51 in FIG. 4). The above “short-term average value” is obtained based on this flowchart.

Symbols used in the flowchart have the following meanings.

c0: traffic counter value recorded last time

c1: traffic counter value recorded this time

q: traffic amount

t0: last recording time

t1: current recording time

d: traffic amount measurement interval (example: about one minute)

Step S11: Decide whether d second has passed since last time or not.

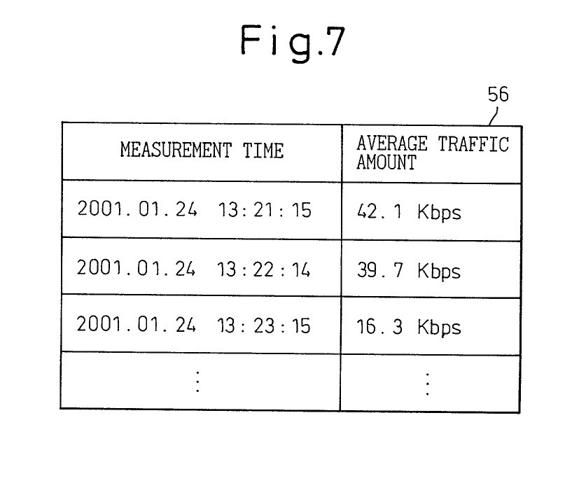

Step S12: If d second has passed, record the average traffic amount (a short-term average value) during the d-second period since last time, into a record table (FIG. 7) within the traffic amount recording unit 52.

Step S13: Overwrite the record this time on the record last time.

Thereafter, the steps S11, S12 and S13 are repeated.

FIG. 7 is a diagram showing the record table within the traffic amount recording unit (52 in FIG. 4).

Values within a record table 56 in FIG. 7 are examples. In this table, the above short-term average value is accumulated as the average traffic amount.

The bandwidth determination automatic adjusting unit 53 shown in FIG. 4 automatically adjusts the bandwidth setting according to the above-described predetermined algorithm by using the average traffic amount shown in FIG. 7. Detailed examples of the predetermined algorithm are shown below.

[First Example of Algorithm]

This is a simple algorithm of “Check a long-term average of traffic amount, and set a bandwidth close to this value”.

More specifically, this algorithm is “to average the actual traffic amount during a one-week period, and re-set a preset bandwidth value to a value slightly larger than the average value, if the average value is too far from the preset bandwidth value”. This kind of simple algorithm can function sufficiently in the situation where the traffic variation is not so extreme and there is always a constant amount of traffic.

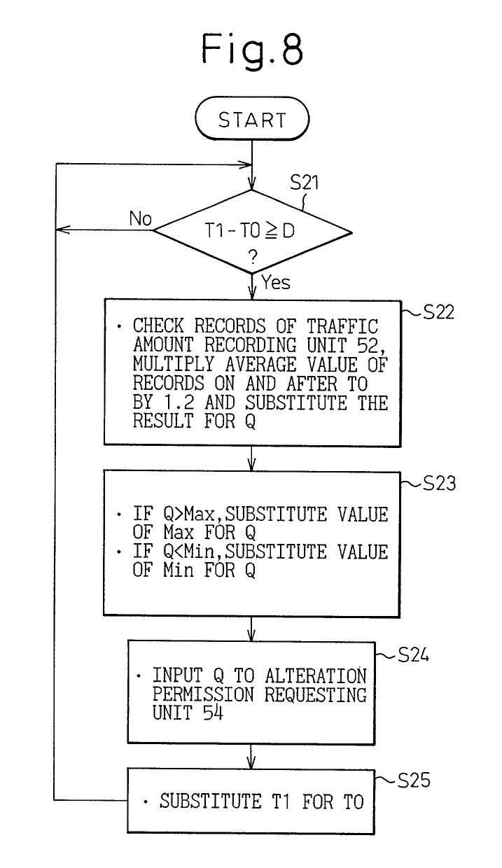

FIG. 8 is a flowchart for explaining the first example of algorithm.

Symbols used in this flowchart have the following meanings.

T0: last recording time

T1: current time

D: traffic setting reviewing interval (example: about one week)

Max: upper limit value of bandwidth setting (for example, 90% of channel capacity)

Mim: lower limit value of bandwidth setting (for example, 10% of channel capacity)

Q: modification value of traffic setting

In the example shown in this drawing, the bandwidth determination automatic adjusting unit 53 operates only once during one week. In other words, D=one week.

When it has been detected that one week has passed since the operation started by referring to a clock in the data repeater equipment 12, the bandwidth determination automatic adjusting unit 53 checks the records of the traffic amount recording unit 52, and averages the records of all the traffic amount recorded during the period from the last operation starting time to the current time.

Then, a value slightly larger (for example, 1.2 times) than this average value is used as a new bandwidth setting value. In other words, according to the algorithm of the present invention, the average traffic amount calculated over a long-term period based on the traffic amount held in the traffic amount holding means 21, is multiplied by k (where k represents a value larger than 1). The value obtained by multiplying k is used as the second preset bandwidth value. In the above example, this k is 1.2.

Each step of the flowchart shown in FIG. 8 will be explained below.

Step S21: Decide whether the interval D has passed since the last time or not.

Step S22: If the interval D has passed, obtain the average traffic amount during this interval D period, and re-set the bandwidth to 120% (k=1.2) of this average traffic amount (to obtain the second preset bandwidth value).

Step S23: Confirm that this preset bandwidth value is within a range from the prescribed upper limit value and the prescribed lower limit value, and determine a new

In other words, according to the algorithm of the present invention, the value obtained by multiplying the average traffic amount by k is adjusted to be within the range from the predetermined upper limit value (Max) and the predetermined lower limit value (Min) of the bandwidth setting. Then, this value is used as the second preset bandwidth value.

Step S24: Indicate the alteration permission requesting unit 54 to update the preset bandwidth value to Q.

Step S25: Overwrite the current record on the last record.

Thereafter, the steps S21 to S25 are repeated.

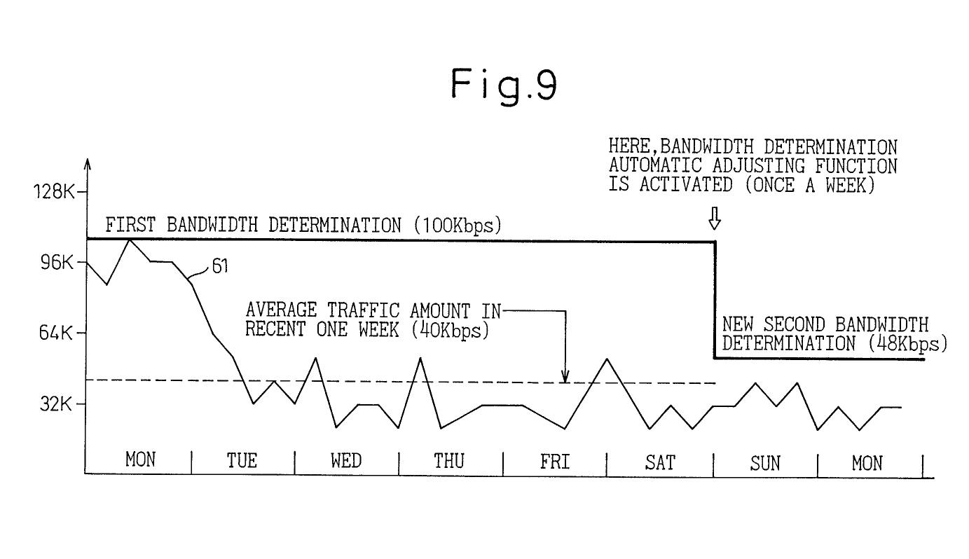

FIG. 9 is a graph showing an operation image based on the first example of algorithm. FIG. 9 shows a graph of a variation (a polygonal line 61) of traffic amount over one week-period.

In FIG. 9, the horizontal axis represents days of the week, and the vertical axis represents record (Kbps) of the traffic amount recording unit 52.

According to the case shown in FIG. 9, the job traffic is reduced on Tuesday because of some changes in jobs or move of an organizations, and the traffic is stabilized at a low level during the rest of the week. Therefore, it is clear that the bandwidth setting becomes waste for a few days. Since the bandwidth determination automatic adjusting unit 53 has detected this early on Sunday morning, it becomes possible to omit the waste by lowering the preset bandwidth value.

As explained above, in the first example of algorithm, the average traffic amount is calculated as a constant value over the long-term period.

[Second Example of Algorithm]

This is an algorithm of “Reading a traffic amount variation pattern over one week, and, in complying with this pattern, adjusting a preset bandwidth value before the traffic amount varies”.

More specifically, this algorithm is “to optimize the preset bandwidth value finely in compliance with an approximate pattern of business activity, as this pattern is roughly determined for each day of the week and time”. This algorithm is effective in the situation where, although the traffic amount variation is extreme, the variation pattern is almost fixed, and it is easy to estimate this pattern.

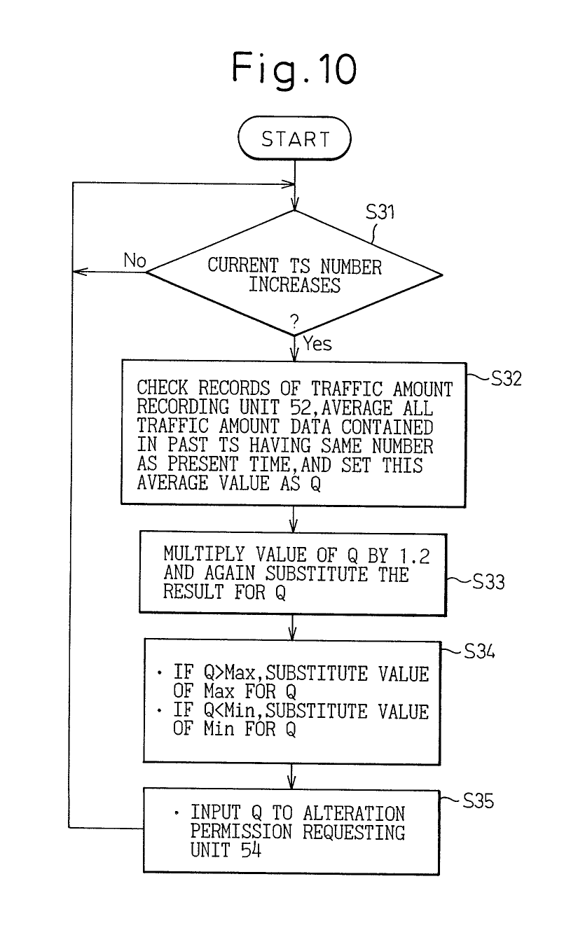

FIG. 10 is a flowchart for explaining the second example of algorithm.

The symbols used in FIG. 10 have the same meanings as those of the symbols used in the flowchart in FIG. 8, except TS. TS denotes a time slot, which is defined as follows.

For example, one week is divided into hours, and each one-hour time zone is called a time slot. When one hour period from hour 0 a.m. to hour 1 a.m. on Monday is called TS-1, hour 23 to hour 24 on Sunday becomes TS-168. The data repeater equipment installed with this algorithm can always understand a “current time TS number (TS-n)” from the clock incorporated in this data repeater equipment.

In other words, the “time slot” is identified by assigning a number to each time zone that is obtained by dividing one week into specific time unit (=time slot length) of one hour, for example. For example, the onehour time zone from hour 0 a.m. to hour 1 a.m. on Monday is defined as TS-1. Then, the one-hour time zone from hour 10 a.m. to hour 11 a.m. on Monday is defined as TS-11, and the one-hour time zone from hour 0 a.m. to hour 1 a.m. on Tuesday is defined as TS-25. The one-hour time zone from hour 23 to hour 24 on Sunday is defined as TS-168.

In the example shown in FIG. 10, the bandwidth determination automatic adjusting unit 53 operates once an hour (when one hour is set as one time slot length).

The the bandwidth determination automatic adjusting unit 53 confirms the current TS number, searches for the record table 56 that stores the past traffic records, extracts traffic records that belongs to the TS having the same number as the current TS number, and averages these records. Based on this, it is possible to obtain “an average value of traffic ‘amount during a period from hour 10 a.m. to hour 11 a.m. on each Monday’ over the past few weeks”, if the current time is hour 10 a.m. on Monday, for example.

Then, the bandwidth determination automatic adjusting unit 53 updates the preset bandwidth value to a value slightly larger (1.2 times) than this average value.

This algorithm is based on the assumption of the existence of a constant pattern that “there is approximately the same traffic amount during the same time zone at the same day of the week, each week”. In the above example, when “during the period from hour 10 a.m. to hour 11 a.m. on Monday” is specified, the records of the past traffic amount during this time slot are averaged. Based on this, it becomes possible to estimate a traffic amount during this one-hour period. A bandwidth slightly larger (k times) than this value is set as the second preset bandwidth value.

Each step of the flowchart shown in FIG. 10 will be explained below.

Step S31: Check whether the TS number has increased by one or not, like from TS31 to TS32, for example. Proceed to the next step each time when the number of the time slot increases (at every one hour).

Step S32: When the current time is TS-112, for example, extract all the recorded traffic amount data included in TS-112 starting from the current data retroactively to the traffic amount in TS-112 one week before, the traffic amount in TS-112 two weeks before, and so on. Then, average all these records.

Step S33: Multiply this average value by 1.2, and use the obtained value for the second preset bandwidth value.

Step S34: Confirm that this preset bandwidth value falls within the range from prescribed Max to Min, and finally determine Q.

In this case,

Max: upper limit value of bandwidth setting (for example, 90% of the channel capacity)

Min: lower limit value of bandwidth setting (for example, 10% of the channel capacity)

Step S35: Indicate the alteration permission requesting unit 54 to update the preset bandwidth value to Q.

Thereafter, the steps S31 to S35 are repeated.

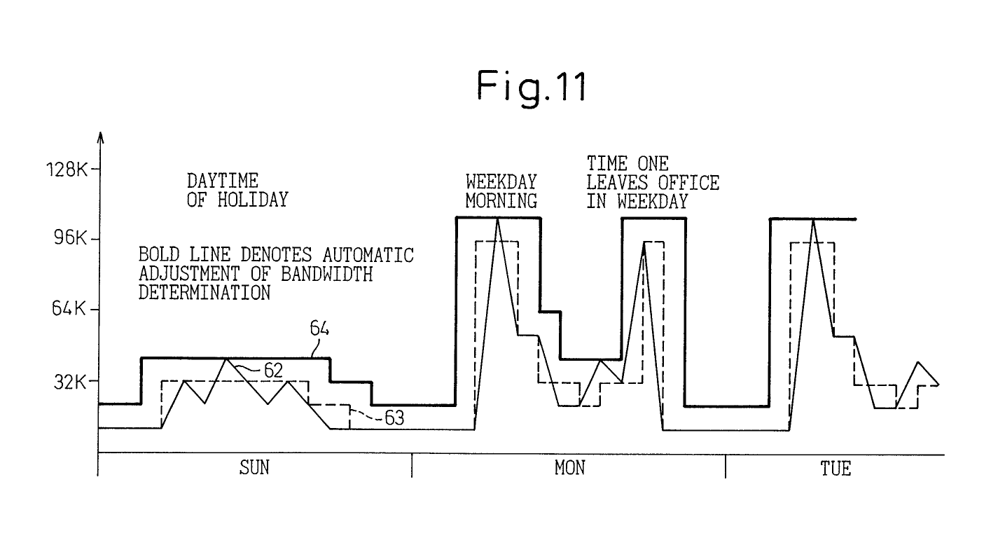

FIG. 11 is a graph showing an operation image based on the second example of algorithm.

In FIG. 11, a polygonal line 62 shows an actual traffic amount. A dotted line 63 shows a result of an average value of past records for each time slot. The pattern of the dotted line 63 becomes close to the pattern of the actual traffic amount. A thick line 64 shows changes in the preset bandwidth values. The pattern of the thick line 64 simply shows a result of the pattern of the dotted line 63 multiplied by 1.2. In FIG. 11, the width between the dotted line 63 and the thick line 64 is intentionally expanded to facilitate the understanding.

As is clear from FIG. 11, according to the second example of algorithm, it is always possible to estimate “an average traffic during the coming one-hour period” based on the past pattern, and adjust the preset bandwidth value in compliance with this estimated pattern.

In summary, in the second example of algorithm, a long-term period is divided into a plurality of time slots (TS), and, in correspondence with each time slot, a past traffic amount in the same time slot is calculated by averaging the records in the same time slots of past, thereby to obtain an average traffic amount.

Last, the operation of the alteration request means 23 and the bandwidth determination managing apparatus 24 shown in FIG. 1 will be explained by taking an example of the alteration permission requesting unit 54 and the bandwidth determination management server 55 shown in FIG. 4 respectively.

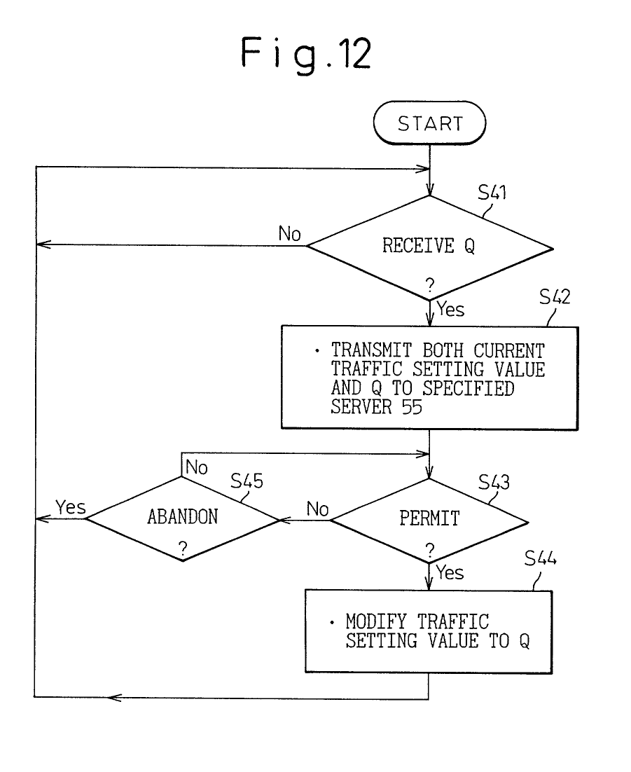

FIG. 12 is a flowchart showing an outline of the operation of the alteration permission requesting unit 54.

Step S41: Check whether Q (a modification value of the traffic setting) has been received from the bandwidth determination automatic adjusting unit 53 or not.

Step S42: If Q has been received, dispatch a request to the bandwidth determination management server 55 to permit the modification of the traffic setting value.

Step S43: Decide whether an ACK response, i.e. permission has been dispatched from the bandwidth determination management server 55 or not.

Step S44: If the permission has been dispatched, automatically update the traffic setting.

Step S45: If a NACK response, i.e. non-permission has been dispatched at step S43, determine whether the modification of the traffic setting value is abandoned or not.

Abandon the modification, if there has been no response after waiting for a constant period of time since the dispatch of the request (due to the system-down of the server 55 or the like) or if the negative response (inhibition of the modification) has lasted.

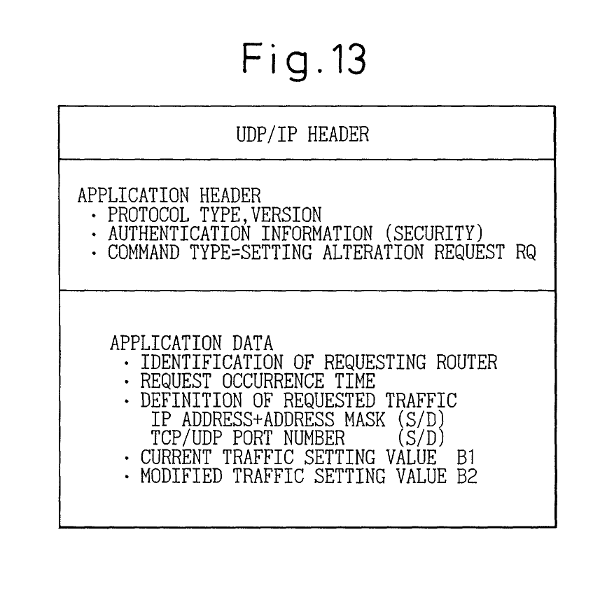

FIG. 13 is a diagram showing one example of a request command from the alteration permission requesting unit 54.

A bandwidth setting alteration request RQ has been assigned to the application header of a packet, as a command type. This application data includes a current traffic setting value B1 (a first preset bandwidth value) and a traffic setting value B2 after the modification (a second preset bandwidth value).

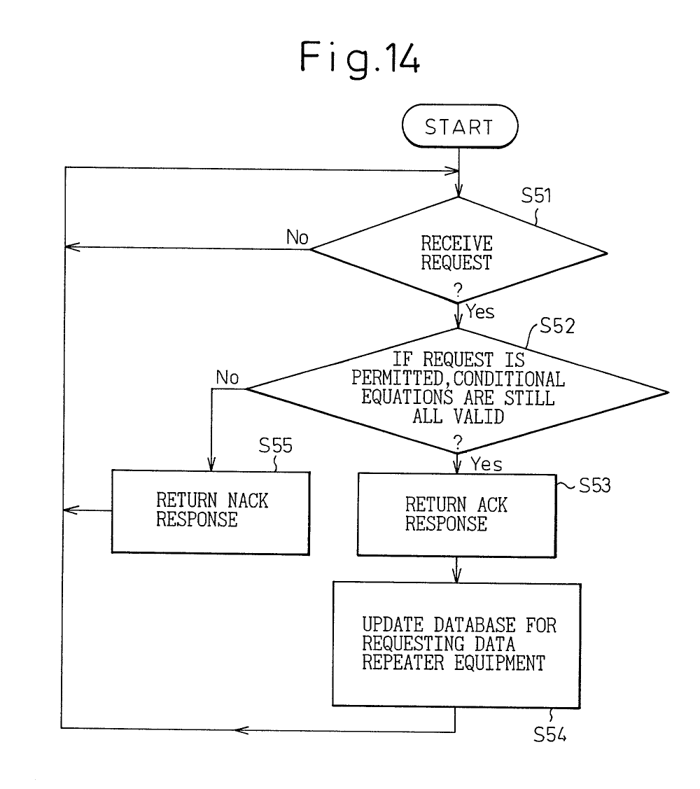

FIG. 14 is a flowchart showing an operation algorithm of the bandwidth determination management server 55.

The operation at each step is as follows. The bandwidth determination management server 55 is input in advance with conditional equations that the preset bandwidth value in each data repeater equipment should satisfy. For example, these conditional equations include “the bandwidth of data repeater equipment X must be larger than the total of the bandwidth of data repeater equipment Y and the bandwidth of data repeater equipment Z”.

Step S51: Check whether the bandwidth setting alteration request RQ has been received from the data repeater equipment or not.

Step S52: The bandwidth determination management server 55 holds the preset bandwidth values of all the data repeater equipment under its management, in database db of the server 55.

By referring to this database, the bandwidth determination management server 55 checks whether all of the conditional equations given in advance are satisfied when the bandwidth has been altered as requested, for the data repeater equipment that has dispatched the bandwidth setting alteration request RQ.

Step S53: If a decision has been made that the given conditional equations are all satisfied, return the ACK response to the related data repeater equipment.

Step S54: Return the ACK response, and update the database db to reflect the preset bandwidth value of the data repeater equipment that has dispatched the request, as per requested. With this operation, the latest setting status is reflected.

Step S55: Return the NACK response to the data repeater equipment, if any one of the conditional equations has not been satisfied at step S52.

Thereafter, the steps S51 to S55 are repeated.

As explained above, there have been the conventional problems of “for effectively utilizing the bandwidth control function, it is necessary to periodically adjust the preset bandwidth value” and “in adjusting the preset bandwidth value, it is necessary to confirm that the setting values are compatible between a plurality of data repeater equipment”. According to the present invention, it is possible to adjust and make compatible the preset bandwidth values, by avoiding the problem of requiring huge human work to achieve this. In other words, according to the present invention, it is possible to automatically carry out the adjustment without requiring human work. Further, it is possible to automatically adjust the preset bandwidth values to make them compatible between a plurality of data repeater equipment. As a result, it is possible to substantially cut the work required for managing the operation to exhibit the bandwidth control function of the data repeater equipment.

What is claimed is:

1. Data repeater equipment having a bandwidth control function, comprising:
traffic amount holding means that holds a traffic amount measured at every short-term period; and
bandwidth adjusting means that calculates an average traffic amount at every long-term period based on the traffic amount held in the traffic amount holding means, compares a bandwidth value corresponding to the calculated average traffic amount with a first preset bandwidth value, thereby to obtain a difference between the two, and re-sets the first bandwidth value to a second preset bandwidth value that minimizes this difference.

2. The data repeater equipment as set forth in claim 1, further comprising:
alteration decision means that decides whether it is possible to permit the alteration of the first preset bandwidth value to the second preset bandwidth value or not, thereby to either permit or inhibit the bandwidth adjusting means to execute the adjustment, based on the decision made.

3. The data repeater equipment as set forth in claim 1, further comprising:
an interface that cooperates with the bandwidth determination managing apparatus that integrally manages the bandwidths of a plurality of data repeater equipment, via the communication channel.

4. The data repeater equipment as set forth in claim 3, further comprising:
alteration request means that makes a request for permitting the alteration of the first preset bandwidth value to the second preset bandwidth value, whereby the alteration request means communicates with the bandwidth determination managing apparatus to make this request and obtain permission, via the interface, and either permits or inhibits the bandwidth adjusting means to execute the adjustment, according to a decision made by the bandwidth determination managing apparatus.

5. The data repeater equipment as set forth in claim 1, further comprising:
a repeater processing unit that performs at least the repeat processing of a packet to be handled and a bandwidth control function, whereby the bandwidth adjusting means executes the bandwidth control to be applied to the repeater processing unit.

6. The data repeater equipment as set forth in claim 5, wherein
said traffic amount holding means includes a traffic amount counter, and the traffic amount counter measures the number of the packets handled by the repeater processing unit.

7. The data repeater equipment as set forth in claim 5, further comprising:
a bandwidth determination unit that holds the preset bandwidth value, whereby the bandwidth determination unit inputs the preset bandwidth value to the bandwidth adjusting means and the repeater processing unit.

8. The data repeater equipment as set forth in claim 1, wherein
said traffic amount holding means divides the number of packets handled during the short-term period by the time corresponding to this period, and uses an obtained short-term average value as the traffic amount to be held.

9. The data repeater equipment as set forth in claim 1, wherein
the bandwidth adjusting means calculates the long-term average traffic amount using a predetermined algorithm.

10. The data repeater equipment as set forth in claim 9, wherein
the data repeater equipment executes the predetermined algorithm based on a predetermined program, with the predetermined program replaceable with any optional one of a plurality of kinds of programs, without changing the structure of the data repeater equipment.

11. The data repeater equipment as set forth in claim 9, wherein
in the predetermined algorithm, the average traffic amount calculated over the long-term period based on the traffic amount held in the traffic amount holding means, is multiplied by k (where k represents a value larger than 1), and the value obtained by multiplying k is used as the second preset bandwidth value.

12. The data repeater equipment as set forth in claim 11, wherein
in the predetermined algorithm, the average traffic amount multiplied by k is adjusted to be within a range from a prescribed upper limit value to a prescribed lower limit value of bandwidth setting, and this value is used as the second preset bandwidth value.

13. The data repeater equipment as set forth in claim 11, wherein
in the predetermined algorithm, the average traffic amount is calculated as a constant value over the long-term period.

14. The data repeater equipment as set forth in claim 11, wherein
in the predetermined algorithm, the long-term period is divided into a plurality of time slots, and, in correspondence with each time slot, a past traffic amount in the same time slot is calculated by averaging the records in the same time slots of past, thereby to obtain the average traffic amount.

15. The data repeater equipment as set forth in claim 2, wherein
the alteration decision means holds a plurality of predetermined conditions, decides whether the second preset bandwidth value satisfies all the conditions or not, and permits the alteration of the first preset bandwidth value to the second preset bandwidth value only when the second preset bandwidth value satisfies all the conditions.

16. The data repeater equipment as set forth in claim 4, wherein
the bandwidth determination managing apparatus holds a plurality of predetermined conditions, when the bandwidth determination managing apparatus has received a request for altering the setting of the first preset bandwidth value to the second preset bandwidth value from the alteration request means, the bandwidth determination managing apparatus decides whether this second preset bandwidth value satisfies all the conditions or not, and when the second preset bandwidth value satisfies all the conditions, the bandwidth determination managing apparatus permits the alteration request means to alter the first preset bandwidth value to the second preset bandwidth value.

17. A bandwidth managing apparatus comprising:
reception means that receives, by cooperating with a plurality of data repeater equipment, a request for altering a bandwidth setting from any one of the plurality of data repeater equipment;
decision means that holds a plurality of conditions relating to the bandwidth setting, and decides whether the request satisfies all the conditions or not; and
response means that makes response to the data repeater equipment to permit the request when the request satisfies all the conditions as a result of the decision made, and not permit the request when the request does not satisfy all the conditions.
